(19) United States
(12) Patent Application Publication
(10) Pub. No.: US 2023/0009051 A1
(43) Pub. Date: Jan. 12, 2023

(54) IMAGE PROCESSING APPARATUS AND MEDICAL IMAGE PROCESSING APPARATUS

(71) Applicant: FUJIFILM Corporation, Tokyo (JP)

(72) Inventor: Misaki GOTO, Tokyo (JP)

(73) Assignee: FUJIFILM Corporation, Tokyo (JP)

(21) Appl. No.: 17/811,469

(22) Filed: Jul. 8, 2022

(30) Foreign Application Priority Data
Jul. 12, 2021 (JP) 2021-114944

(51) Int. Cl. G06T 7/00; G06T 5/50

(52) U.S. Cl. CPC G06T 7/0012; G06T 5/50; G06T 2207/20081; G06T 2207/10068; G06T 2207/10024; G06T 2207/20084; G06T 2207/30096

(57) ABSTRACT

A first image acquisition unit acquires a first image that is captured by a sensor having a first pixel arrangement pattern and includes a first reproduction band in a frequency domain. A second image acquisition unit acquires a second image that is captured by a sensor having a second pixel arrangement pattern and includes a second reproduction band different from the first reproduction band in the frequency domain. A correction processing unit generates a first correction image by correction processing of at least reducing or deleting high-frequency components that are not included in the second reproduction band within the first reproduction band.

### CROSS-REFERENCE TO RELATED APPLICATIONS

This application claims priority under 35 U.S.C § 119(a) to Japanese Patent Application No. 2021-114944 filed on 12 Jul. 2021. The above application is hereby expressly incorporated by reference, in its entirety, into the present application.

### BACKGROUND OF THE INVENTION

### 1. Field of the Invention

The present invention relates to an image processing apparatus and a medical image processing apparatus that perform learning such as machine learning.

### 2. Description of the Related Art

In recent years, determination of an examination target such as a lesion portion is performed by using learning such as machine learning and deep learning. In machine learning, improvement in accuracy can be expected by learning a large amount of images of the examination target. However, depending on an environment or a situation for collecting data for learning, there may be a case where some data required for learning is not sufficiently acquired. For example, in a case where machine learning is performed on images of treatment tools for endoscope, it is difficult to collect all the images of many treatment tools on the market. For this reason, in JP2020-141995A (corresponding to US2020/285876A1), a superposed image for image recognition is generated in a pseudo manner by separately collecting a foreground image of only an endoscopic treatment tool in which a background such as an internal body does not appear and a background endoscopic image of only a background such as an internal body and superimposing the foreground image and the background endoscopic image.

### SUMMARY OF THE INVENTION

As a sensor such as an imaging sensor that is used for imaging of an image, there are various sensors having different pixel arrangement patterns. The images that are captured by sensors having different pixel arrangement patterns have different image resolutions, and include different reproduction bands in a frequency domain. In learning as described above, in a case where an image for learning obtained by a sensor having a specific pixel arrangement pattern is insufficient, it is difficult to maintain accuracy of learning using the image from the sensor having the specific pixel arrangement pattern.

An object of the present invention is to provide an image processing apparatus and a medical image processing apparatus capable of maintaining accuracy of learning even in a situation where an image from a sensor having a specific pixel arrangement pattern is insufficient.

According to an aspect of the present invention, there is provided an image processing apparatus including: a processor configured to acquire a first image that is captured by a sensor having a first pixel arrangement pattern and includes a first reproduction band in a frequency domain, acquire a second image that is captured by a sensor having a second pixel arrangement pattern and includes a second reproduction band different from the first reproduction band in the frequency domain, generate a first correction image by correction processing of at least reducing or deleting high-frequency components that are not included in the second reproduction band within the first reproduction band of the first image, and perform learning of a learning model for determining an examination target by using the first correction image and the second image.

Preferably, the second reproduction band is a band obliquely inclined with respect to the first reproduction band in the frequency domain, and the high-frequency components are first high-frequency components in an oblique direction that are not included in the second reproduction band. Preferably, the second reproduction band is a band lower than the first reproduction band in the frequency domain, and the high-frequency components are second high-frequency components that are not included in the second reproduction band. Preferably, the second reproduction band is a band that is lower than high-frequency components of the first reproduction band in a horizontal direction and a vertical direction in the frequency domain and that is obliquely inclined with respect to the first reproduction band. Preferably, in the correction processing, as the high-frequency components, third high-frequency components that are components that are not included in the second reproduction band are reduced or deleted, and medium-frequency components that are not included in the second reproduction band in the frequency domain are reduced or deleted.

Preferably, the second reproduction band is a band obliquely inclined with respect to the first reproduction band by rotating the first reproduction band by a specific angle in the frequency domain, the high-frequency components are fourth high-frequency components in an oblique direction that are not included in the second reproduction band, and in the correction processing, fifth high-frequency components that are included in the second reproduction band are added in addition to the fourth high-frequency components.

Preferably, the first reproduction band has a square grid shape, and the second reproduction band has a rhombus shape. Preferably, the first reproduction band and the second reproduction band have a square grid shape. Preferably, the first pixel arrangement pattern is a pattern in which pixels are arranged in a square grid shape, and the second pixel arrangement pattern is a pattern in which pixels are arranged in a checkered grid shape. Preferably, the first pixel arrangement pattern and the second pixel arrangement pattern are patterns in which pixels are arranged in a square grid shape or a checkered grid shape.

Preferably, the first image and the second image are images acquired by an endoscope. According to another aspect of the present invention, there is provided a medical image processing apparatus including: a learning model obtained by the learning in the image processing apparatus described above, in which an examination target is determined by using the learning model.

According to the present invention, it is possible to maintain accuracy of learning even in a situation where an image from a sensor having a specific pixel arrangement pattern is insufficient.

### BRIEF DESCRIPTION OF THE DRAWINGS

FIG. 1 is a block diagram illustrating a hardware configuration of an image processing apparatus.

FIG. 2 is an explanatory diagram representing signals obtained in each pixel by a sensor having a first pixel arrangement pattern, (A) represents signals included in pixels before demosaicing processing, and (B) represents signals included in pixels after demosaicing processing.

FIG. 3 is an explanatory diagram representing a first reproduction band of a first image, (A) represents the first reproduction band of the first image before demosaicing processing, and (B) represents the first reproduction band of the first image after demosaicing processing.

FIG. 4 is an explanatory diagram representing signals obtained in each pixel by a sensor having a second pixel arrangement pattern, (A) represents signals included in pixels before demosaicing processing, and (B) represents signals included in pixels after demosaicing processing.

FIG. 5 is an explanatory diagram representing a second reproduction band of a second image in a first embodiment, (A) represents the second reproduction band of the second image before demosaicing processing, and (B) represents the second reproduction band of the second image after demosaicing processing.

FIG. 6 is a block diagram illustrating a software configuration of the image processing apparatus.

FIG. 7A is an explanatory diagram representing the first reproduction band after demosaicing processing, and FIG. 7B is an explanatory diagram representing the second reproduction band after demosaicing processing.

FIG. 8 is an explanatory diagram illustrating correction processing according to the first embodiment.

FIG. 9 is a flowchart illustrating a series of flows for generation of a first correction image and learning.

FIG. 10 is a schematic diagram of an endoscope system.

FIG. 11 is an explanatory diagram representing a second reproduction band of a second image in a second embodiment, (A) represents the second reproduction band of the second image before demosaicing processing, and (B) represents the second reproduction band of the second image after demosaicing processing.

FIG. 12 is a graph illustrating the first reproduction band of the first image after demosaicing processing in the second embodiment.

FIG. 13 is an explanatory diagram illustrating correction processing according to the second embodiment.

FIG. 14 is an explanatory diagram representing a second reproduction band of a second image in a third embodiment, (A) represents the second reproduction band of the second image before demosaicing processing, and (B) represents the second reproduction band of the second image after demosaicing processing.

FIG. 15 is a graph illustrating the first reproduction band of the first image after demosaicing processing in the third embodiment.

FIG. 16 is an explanatory diagram illustrating correction processing according to the third embodiment.

FIG. 17 is an explanatory diagram representing a second reproduction band of a second image in a fourth embodiment, (A) represents the second reproduction band of the second image before demosaicing processing, and (B) represents the second reproduction band of the second image after demosaicing processing.

FIG. 18 is a graph illustrating the first reproduction band of the first image after demosaicing processing in the fourth embodiment.

FIG. 19 is an explanatory diagram illustrating correction processing according to the fourth embodiment.

### DESCRIPTION OF THE PREFERRED EMBODIMENTS

### First Embodiment

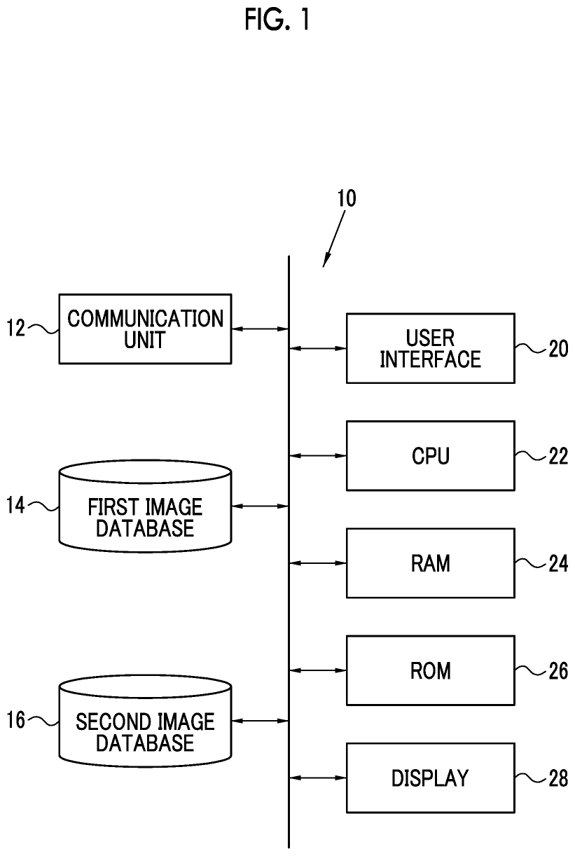

As illustrated in FIG. 1, an image processing apparatus 10 is configured with a personal computer or a workstation. The image processing apparatus 10 includes a communication unit 12, a first image database 14, a second image database 16, a user interface 20, a central processing unit (CPU) 22, a random access memory (RAM) 24, and a read only memory (ROM) 26, and a display 28. The communication unit 12 is an interface that performs communication processing with an external apparatus in a wired manner or a wireless manner and exchanges information with the external apparatus.

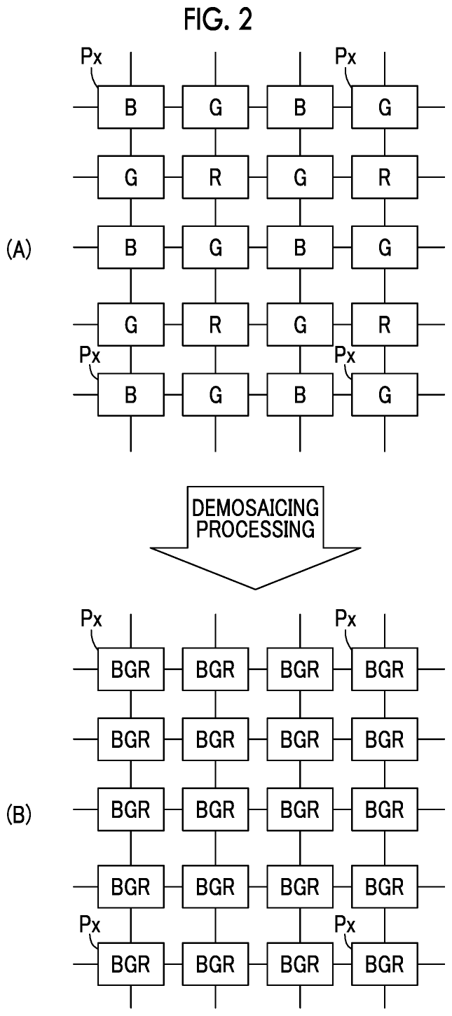

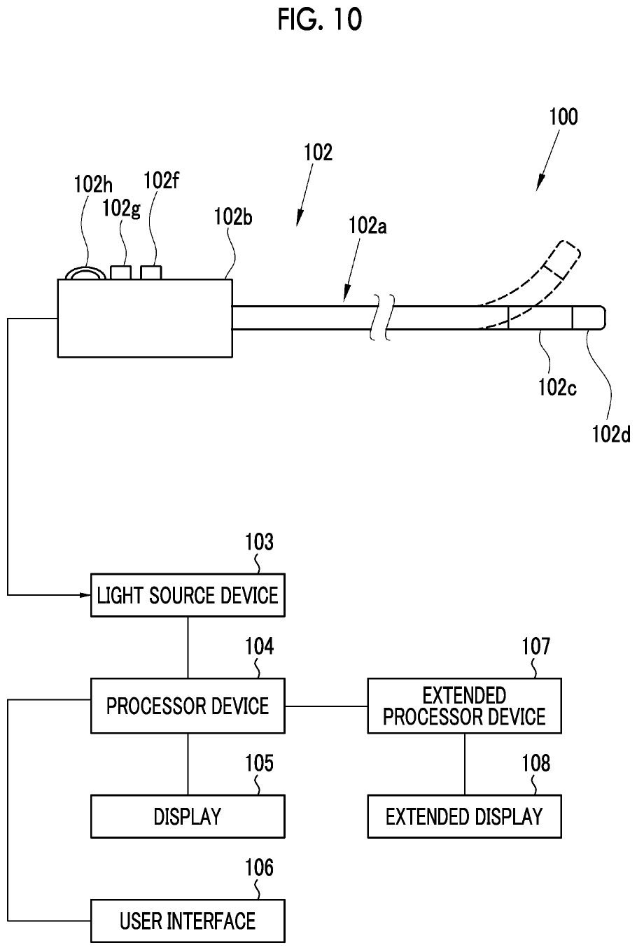

The first image database 14 is a large-capacity storage device, and stores a first image that is captured by a sensor having a first pixel arrangement pattern, the first image including a first reproduction band in a frequency domain. In the first embodiment, as illustrated in (A) of FIG. 2, the first image database 14 stores the first image that is captured by a sensor having a pattern as a first pixel arrangement pattern in which actual pixels Px are arranged in a square grid shape. Preferably, the first image is an image acquired by an endoscope 102 (refer to FIG. 10).

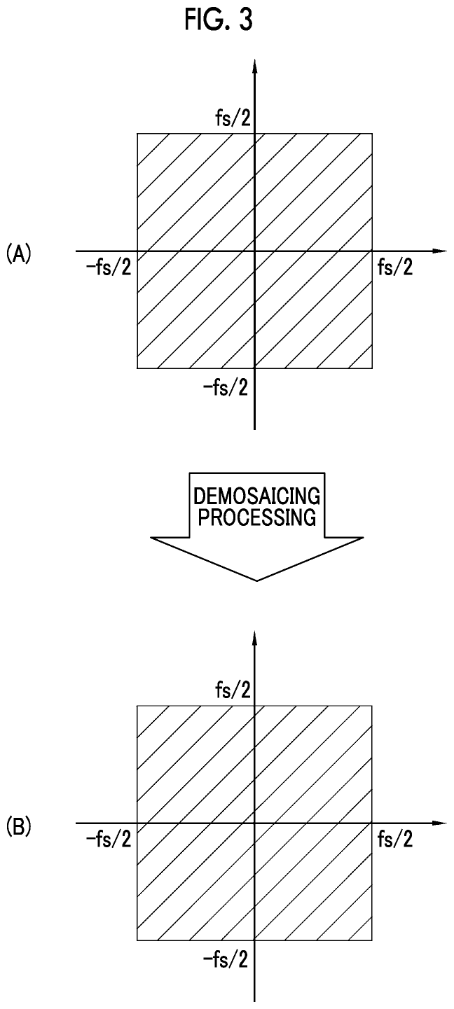

In a case where the sensor having the first pixel arrangement pattern is a color sensor such as an RGB sensor or a CMYG sensor, an image of a subject is captured by the sensor having the first pixel arrangement pattern, and thus the first image before demosaicing processing is obtained. As illustrated in (A) of FIG. 3, the first image before demosaicing processing includes a first reproduction band before demosaicing processing in a frequency domain. The first reproduction band before demosaicing processing has a square grid shape. In (A) of FIG. 3, a longitudinal axis represents a spatial frequency in a vertical direction, and a lateral axis represents a spatial frequency in a horizontal direction. fs is a sampling frequency, and fs/2 is a Nyquist frequency. The same applies to the following.

By performing demosaicing processing on the first image before demosaicing processing, as illustrated in (B) of FIG. 2, the first image in which information of all colors is included in each of the actual pixels Px is obtained. (A) and (B) of FIG. 2 illustrate the first pixel arrangement pattern of an RGB sensor before demosaicing processing and after demosaicing processing. Each of the actual pixels Px before demosaicing processing includes only information of any one of an R signal, a G signal, or a B signal. On the other hand, each of the actual pixels Px after demosaicing processing includes three pieces of information of an R signal, a G signal, and a B signal. Further, as illustrated in (B) of FIG. 3, the first image after demosaicing processing includes a first reproduction band after demosaicing processing in a frequency domain. The first reproduction band after demosaicing processing has a square grid shape as in the first reproduction band before demosaicing processing.

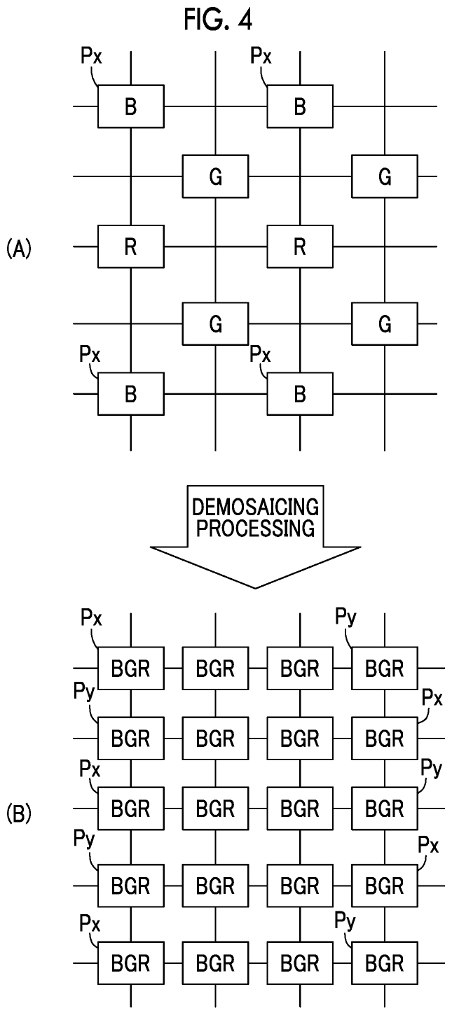

The second image database 16 is a large-capacity storage device, and stores a second image that is captured by a sensor having a second pixel arrangement pattern, the second image including a second reproduction band in a frequency domain. In the first embodiment, as illustrated in (A) of FIG. 4, the second image database 16 stores the second image that is captured by a sensor having a checkered grid shape as a second pixel arrangement pattern. The pattern having a checkered grid shape is a pattern including a first pixel group in which actual pixels Px are arranged in a specific direction at a specific interval and a second pixel group in which actual pixels Px are arranged in a specific direction at a specific interval and which is arranged at a specific distance from the first pixel group. Preferably, the second image is an image acquired by an endoscope 102 (refer to FIG. 10).

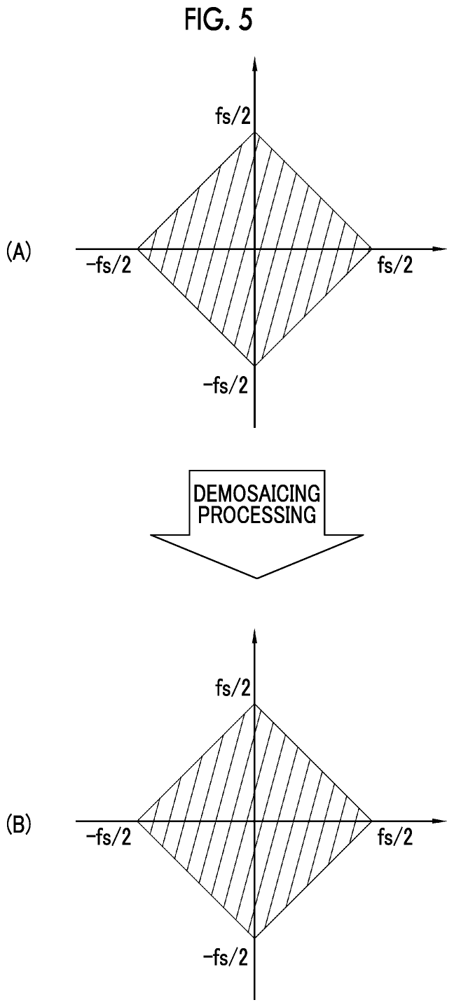

In a case where the sensor having the second pixel arrangement pattern is a color sensor such as an RGB sensor or a CMYG sensor, an image of a subject is captured by the sensor having the second pixel arrangement pattern, and thus the second image before demosaicing processing is obtained. As illustrated in (A) of FIG. 5, the second image before demosaicing processing includes a second reproduction band before demosaicing processing in a frequency domain. The second reproduction band before demosaicing processing has a rhombus shape.

By performing demosaicing processing on the second image before demosaicing processing, as illustrated in (B) of FIG. 4, the second image in which information of all colors is included in each of the actual pixels Px is obtained. (A) and (B) of FIG. 4 illustrate the second pixel arrangement pattern of an RGB sensor before demosaicing processing and after demosaicing processing. Each of the actual pixels Px before demosaicing processing includes only information of any one of an R signal, a G signal, or a B signal. On the other hand, each of the actual pixels Px after demosaicing processing includes three pieces of information of an R signal, a G signal, and a B signal. In addition, an imaginary pixel Py between adjacent actual pixels Px also includes three pieces of information of an R signal, a G signal, and a B signal. Further, as illustrated in (B) of FIG. 5, the second image after demosaicing processing includes a second reproduction band after demosaicing processing in a frequency domain. The second reproduction band after demosaicing processing has a rhombus shape as in the second reproduction band before demosaicing processing.

The user interface 20 is an input interface that receives various operation inputs. As the user interface 20, a keyboard or a mouse connected in a wired manner or a wireless manner is used.

The CPU 22 is a processor, reads various programs stored in the ROM 26 or a hard disk (not illustrated), and executes various processing. The RAM 24 is used as a work area of the CPU 22. The RAM 24 temporarily stores the read program and various data. As the display 28, various monitors such as a liquid crystal monitor are used. The display 28 displays necessary information. A graphical user interface (GPU) may be provided in the image processing apparatus 10.

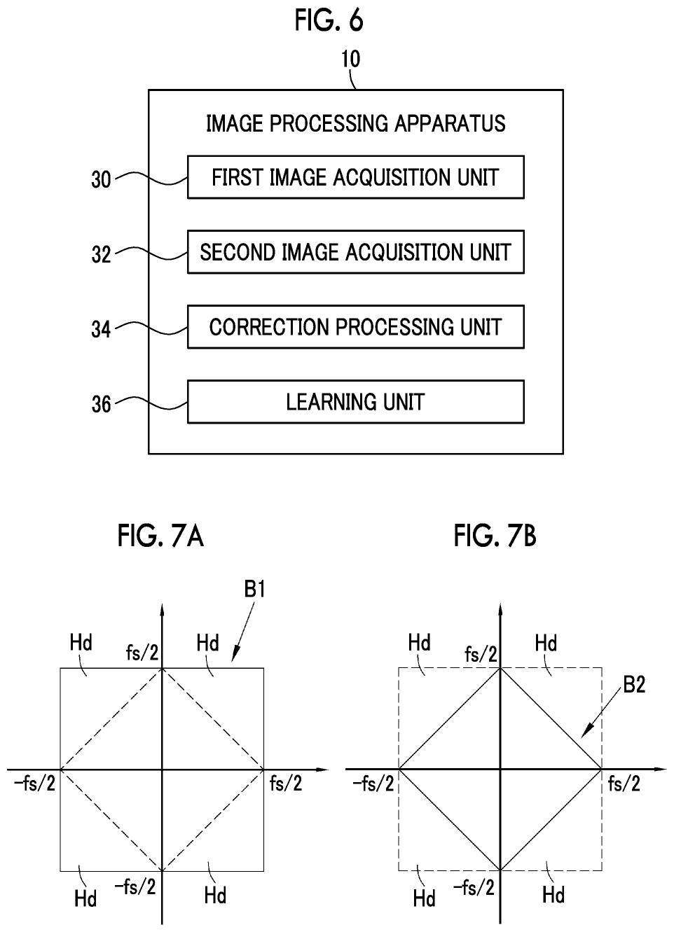

As illustrated in FIG. 6, the image processing apparatus 10 realizes functions of a first image acquisition unit 30, a second image acquisition unit 32, a correction processing unit 34, and a learning unit 36 by executing various programs stored in the ROM 26 by the CPU 22. The first image acquisition unit 30 acquires the first image from the first image database 14 and transmits the first image to the correction processing unit 34. The second image acquisition unit 32 acquires the second image from the second image database 16 and transmits the second image to the learning unit 36.

The correction processing unit 34 generates a first correction image by correction processing of at least reducing or deleting high-frequency components as reduction targets that are not included in the second reproduction band within the first reproduction band of the first image. In the first embodiment, as illustrated in FIG. 7A and FIG. 7B, the second reproduction band B2 is a band that includes frequency components having frequencies which are the same as frequencies of high-frequency components of the first reproduction band B1 in the horizontal direction and the vertical direction in the frequency domain and that is obliquely inclined (rhombus shape) with respect to the first reproduction band B1 (square grid shape). In this case, correction processing is performed on the second reproduction band B2. A fact that the second reproduction band B2 is obliquely inclined with respect to the first reproduction band B1 means that a line defining the second reproduction band B2 intersects with a line defining the first reproduction band B1 at a specific angle.

As illustrated in FIG. 7A, in the first reproduction band B1 of the first image after demosaicing processing, high-frequency components Hd in an oblique direction are included. On the other hand, as illustrated in FIG. 7B, in the second reproduction band B2 of the second image after demosaicing processing, high-frequency components Hd in an oblique direction are not included. Since the second image does not include high-frequency components Hd in the oblique direction, noise such as pattern noise may occur on the actual image. In a case where a second image for learning that is to be used by the learning unit 36 is insufficient, it is preferable to generate a first correction image for learning from the first image in a pseudo manner by the correction processing. In FIG. 7A, a region Hd surrounded by solid lines represents the high-frequency components Hd in the oblique direction. In FIG. 7B, a region Hd surrounded by two dotted lines and one solid line represents high-frequency components in the oblique direction.

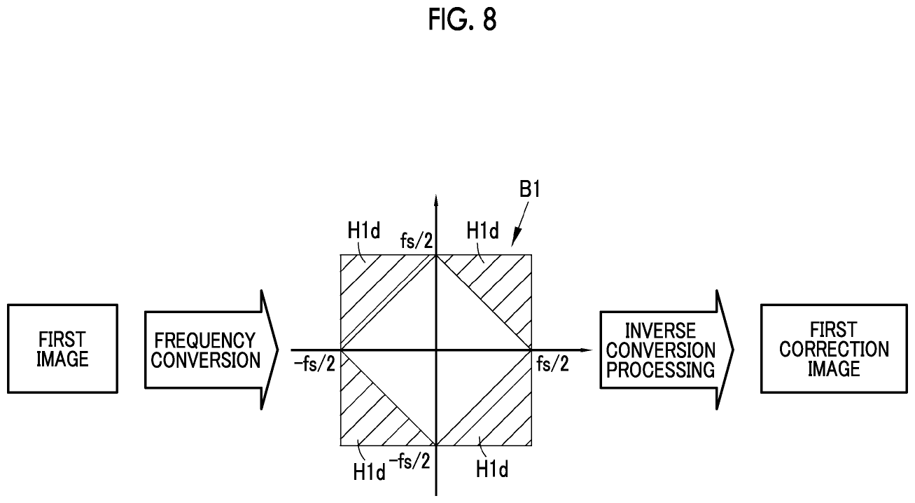

Specifically, as illustrated in FIG. 8, in the correction processing, the first image is converted into an image in a frequency domain, and high-frequency components H1 as reduction targets that are not included in the second reproduction band B2 within the first reproduction band B1 of the first image are reduced or deleted. The high-frequency components H1 as reduction targets are first high-frequency components H1d (hatching region) in the oblique direction. By performing inverse conversion processing on the first image in which the high-frequency components H1 as reduction targets are reduced or deleted, a first correction image is generated, the inverse conversion processing being processing of converting an image in a frequency domain into an image in a pixel value domain.

The learning unit 36 performs learning of a learning model for determining an examination target by using the first correction image and the second image. The learning unit 36 configures a convolution neural network (CNN) which is one of learning models. The CNN is a determiner for determining an examination target. In order to determine an examination target, the CNN has a structure including a plurality of layers, and holds a plurality of weight parameters. The CNN can change an unlearned model into a learned model by updating the weight parameter from an initial value to an optimum value by using the first correction image and the second image. The learning unit 36 may perform learning of the learning model based on reinforcement learning or deep reinforcement learning in addition to machine learning such as CNN using the first correction image to which training data is added and the second image.

Examples of the examination target that is to be determined by the learning model include a lesion portion represented by cancer, a trace of a treatment, a trace of a surgery, an organ, a portion in an organ, a bleeding portion, a benign tumor portion, and an inflamed portion (including a so-called inflammation and a portion including a change such as bleeding or atrophy), a cauterized trace by heating, a marking portion marked by coloring with a coloring agent or a fluorescent agent, and a region including a biopsied portion on which a bioptic examination (so-called biopsy) is performed. That is, the examination target may be a region including a lesion, a region in which there is a possibility of a lesion, a region in which a certain treatment such as a biopsy is performed, a treatment tool such as a clip or a forceps, or a region that requires detailed observation regardless of a possibility of a lesion, such as a dark portion (a region behind folds, a region in which observation light is difficult to reach due to a depth of a lumen, or the like). Further, the examination target may be a malignancy grade, a degree of an inflammation, scar recognition for treatment, or the like. In the determination processing, a region including at least one of a lesion portion, a trace of a treatment, a trace of a surgery, a bleeding portion, a benign tumor portion, an inflamed portion, a marking portion, or a biopsied portion is determined as an examination target. Further, in recognition of an organ or a portion, a region of a normal mucous membrane may be an examination target.

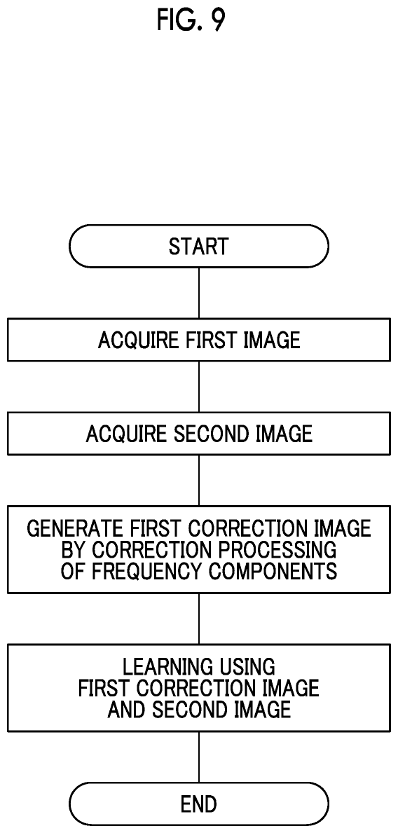

Next, a series of flows for generating a first correction image for learning in a pseudo manner from a first image will be described with reference to a flowchart illustrated in FIG. 9. First, the first image acquisition unit 30 acquires, from the first image database 14, a first image that is captured by a sensor having a first pixel arrangement pattern, the first image including a first reproduction band in a frequency domain. Further, the second image acquisition unit 32 acquires, from the second image database 16, a second image that is captured by a sensor having a second pixel arrangement pattern, the second image including a second reproduction band in a frequency domain.

The correction processing unit 34 creates a first correction image by correction processing of at least reducing or deleting high-frequency components as reduction targets that are not included in the second reproduction band within the first reproduction band of the first image. The learning unit 36 performs learning of a learning model for determining an examination target by using the first correction image and the second image.

The learning model used by the learning unit 36 of the image processing apparatus 10 can be used for determining the examination target by various medical image processing apparatuses. For example, in an endoscope system 100 illustrated in FIG. 10, the learning model may be used for determining an examination target such as a lesion portion. The endoscope system 100 includes an endoscope 102, a light source device 103, a processor device 104, a display 105, a user interface 106, an extended processor device 107, and an extended display 108.

The endoscope 102 is optically connected to the light source device 103, and is electrically connected to the processor device 104. The endoscope 102 includes an insertion part 102a to be inserted into a body of an observation target, an operating part 102b provided at a proximal end portion of the insertion part 102a, and a bendable part 102c and a tip part 102d provided on a distal end side of the insertion part 102a. The bendable part 102c bends by operating the operating part 102b. The tip part 102d is directed in a desired direction by a bending operation of the bendable part 102c. The tip part 102d is provided with sensors (not illustrated) that capture an image of an observation target. The sensors include the sensor having the first pixel arrangement pattern, the sensor having the second pixel arrangement pattern, and the like.

Further, the operating part 102b includes an observation mode switching switch 102f that is used for a switching operation of an observation mode, a still image acquisition instruction switch 102g that is used for instructing acquisition of a still image of an observation target, and a zoom operating part 102h that is used for an operation of enlargement display or reduction display of an examination target.

The processor device 104 is electrically connected to the display 105 and the user interface 106. The display 105 outputs and displays an image or information of an observation target processed by the processor device 104. The user interface 106 includes a keyboard, a mouse, a touch pad, a microphone, and the like, and has a function of receiving an input operation such as function setting.

The extended processor device 107 is electrically connected to the processor device 104. The learning model used by the learning unit 36 of the image processing apparatus 10 is preferably provided in the extended processor device 107. In the extended processor device 107 corresponding to the medical image processing apparatus, the image input from the processor device 104 is input to the learning model, and a determination result of an examination target is output from the learning model. The extended display 108 outputs and displays an image, information, or the like processed by the extended processor device 17. The learning model used by the learning unit 36 of the image processing apparatus 10 may be provided in the processor device 104.

### Second Embodiment

In a second embodiment, in a case where a resolution of the second image that is captured by the sensor having the second pixel arrangement pattern is lower than a resolution of the first image that is captured by the sensor having the first pixel arrangement pattern, in order to generate a second image for learning in a pseudo manner from the first image, correction processing is performed on the first image. Others are the same as those in the first embodiment.

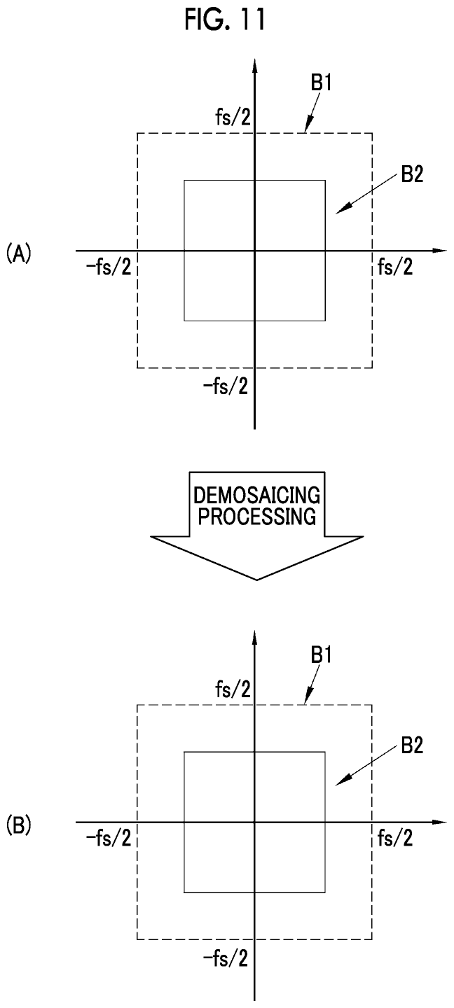

Specifically, the first pixel arrangement pattern and the second pixel arrangement pattern have the same square grid shape, and the resolution of the second image is lower than the resolution of the first image. In this case, in the second image before demosaicing processing, as illustrated in (A) of FIG. 11, in the frequency domain, frequencies of frequency components of the second reproduction band B2 before demosaicing processing that has a square grid shape in the horizontal direction, the vertical direction, and the oblique direction are lower than the first reproduction band B1 before demosaicing processing that has a square grid shape. Further, as illustrated in (B) of FIG. 11, in the frequency domain, as in the case before demosaicing processing, frequencies of frequency components of the second reproduction band B2 after demosaicing processing that has a square grid shape in the horizontal direction, the vertical direction, and the oblique direction are lower than the first reproduction band B1 after demosaicing processing that has a square grid shape.

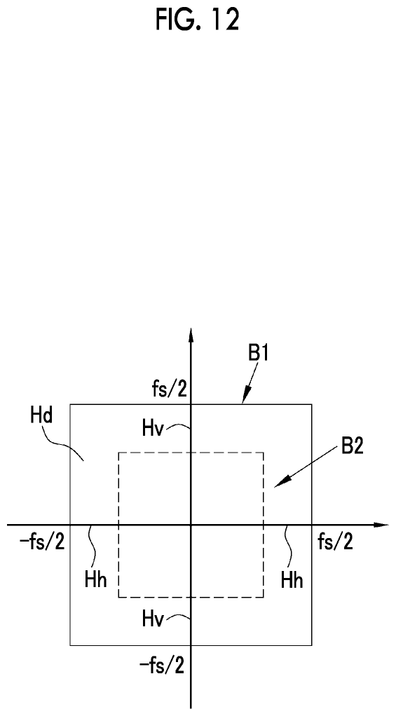

In the second embodiment, in order to generate a second image for learning illustrated in (B) of FIG. 11 in a pseudo manner from the first image, correction processing is performed on the first image. Here, in a stage before the correction processing, as illustrated in FIG. 12, the first reproduction band B1 of the first image (after demosaicing processing) includes high-frequency components Hh, Hv, and Hd in the horizontal direction, the vertical direction, and the oblique direction that are not included in the second reproduction band B2 of the second image (after demosaicing processing).

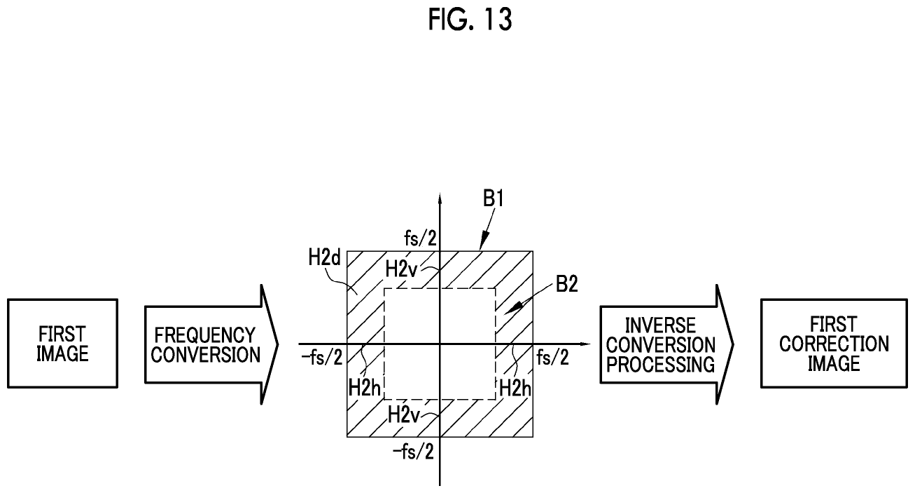

As illustrated in FIG. 13, in the correction processing according to the second embodiment, the first image is converted into an image in a frequency domain, and high-frequency components H2 as reduction targets that are not included in the second reproduction band within the first reproduction band of the first image are reduced or deleted. The high-frequency components H2 as reduction targets are second high-frequency components H2h, H2v, and H2d in the horizontal direction, the vertical direction, and the oblique direction. By performing inverse conversion processing on the first image in which the high-frequency components H2 as reduction targets are reduced or deleted, a first correction image is generated, the inverse conversion processing being processing of converting an image in a frequency domain into an image in a pixel value domain.

### Third Embodiment

In a third embodiment, the second reproduction band of the second image is a band that is lower than frequencies of high-frequency components of the first reproduction band in the horizontal direction and the vertical direction in the frequency domain and that is obliquely inclined with respect to the first reproduction band. In this case, in order to generate a second image for learning in a pseudo manner from the first image, correction processing is performed on the first image. Others are the same as those in the first embodiment.

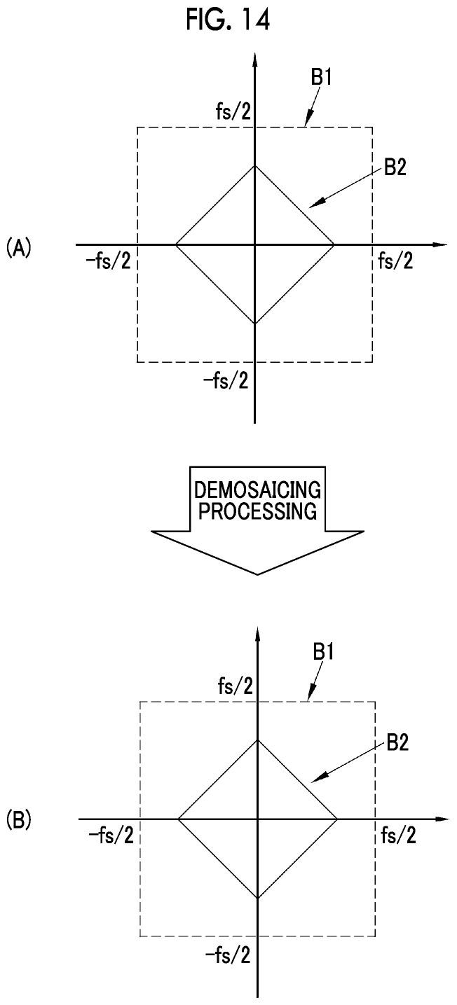

Specifically, in a case where the first pixel arrangement pattern has a square grid shape while the second pixel arrangement pattern has a checkered grid shape, in the second image before demosaicing processing, as illustrated in (A) of FIG. 14, in the frequency domain, frequencies of frequency components of the second reproduction band B2 before demosaicing processing that has a rhombus shape in the horizontal direction, the vertical direction, and the oblique direction are lower than the first reproduction band B1 before demosaicing processing that has a square grid shape. Further, as illustrated in (B) of FIG. 14, in the frequency domain, as in the case before demosaicing processing, frequencies of frequency components of the second reproduction band B2 after demosaicing processing that has a rhombus shape in the horizontal direction, the vertical direction, and the oblique direction are lower than the first reproduction band B1 after demosaicing processing that has a square grid shape.

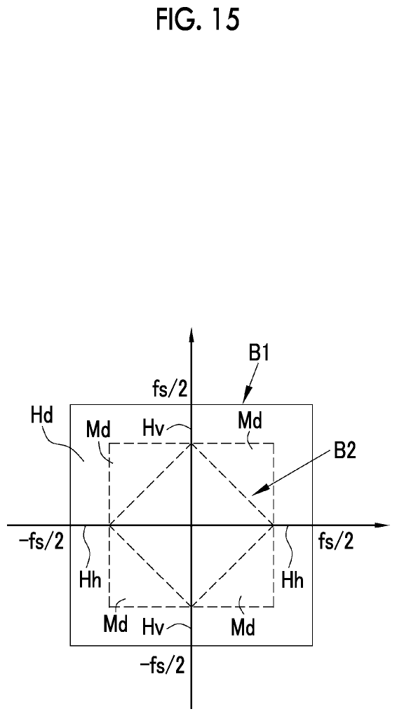

In the third embodiment, in order to generate a second image for learning illustrated in (B) of FIG. 14 in a pseudo manner from the first image, correction processing is performed on the first image. Here, in a stage before the correction processing, as illustrated in FIG. 15, the first reproduction band B1 of the first image (after demosaicing processing) includes medium-frequency components Md in the oblique direction that are not included in the second reproduction band B2, in addition to high-frequency components Hh, Hv, and Hd in the horizontal direction, the vertical direction, and the oblique direction that are not included in the second reproduction band B2 of the second image (after demosaicing processing).

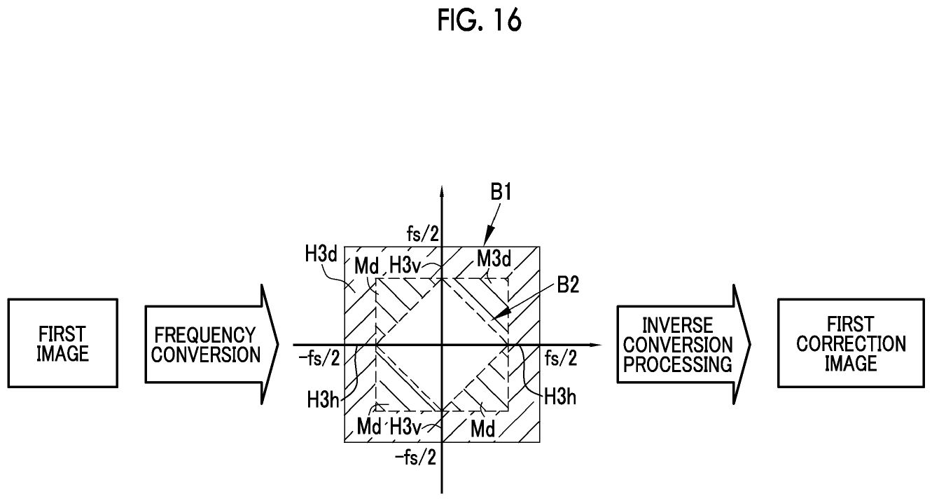

As illustrated in FIG. 16, in the correction processing according to the third embodiment, the first image is converted into an image in a frequency domain, and medium-frequency components MF as reduction targets that are not included in the second reproduction band in the frequency domain are reduced or deleted in addition to high-frequency components H3 as reduction targets that are not included in the second reproduction band within the first reproduction band of the first image. The high-frequency components H3 as reduction targets are third high-frequency components H3h, H3v, and H3d in the horizontal direction, the vertical direction, and the oblique direction. Further, the medium-frequency components MF as reduction targets are medium-frequency components Md in the oblique direction. By performing inverse conversion processing on the first image in which the high-frequency components H3 as reduction targets and the medium-frequency components as reduction targets are reduced or deleted, a first correction image is generated, the inverse conversion processing being processing of converting an image in a frequency domain into an image in a pixel value domain.

### Fourth Embodiment

In a fourth embodiment, the second reproduction band of the second image is a band obliquely inclined with respect to the first reproduction band by rotating the first reproduction band by a specific angle in the frequency domain. In this case, in order to generate a second image for learning in a pseudo manner from the first image, correction processing is performed on the first image. Others are the same as those in the first embodiment.

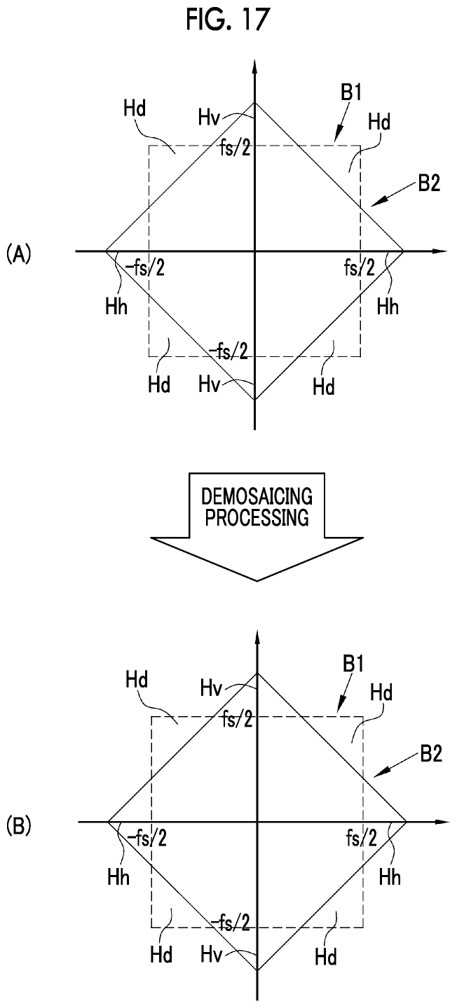

Specifically, in a case where the first pixel arrangement pattern has a square grid shape while the second pixel arrangement pattern has a checkered grid shape, in the second image before demosaicing processing, as illustrated in (A) of FIG. 17, in the frequency domain, the second reproduction band B2 before demosaicing processing that has a rhombus shape is a band obtained by rotating the first reproduction band B1 before demosaicing processing that has a square grid shape by 90 degrees. In this case, frequencies of specific frequency components Hd in the oblique direction are lower than the first reproduction band B1, whereas frequencies of specific frequency components Hh and Hv in the horizontal direction and the vertical direction are higher than the first reproduction band B1. Further, as illustrated in (B) of FIG. 17, in the frequency domain, as in the case before demosaicing processing, in the second reproduction band B2 after demosaicing processing that has a rhombus shape, frequencies of specific frequency components Hd in the oblique direction are lower than the first reproduction band B1, whereas frequencies of specific frequency components Hh and Hv in the horizontal direction and the vertical direction are higher than the first reproduction band B1.

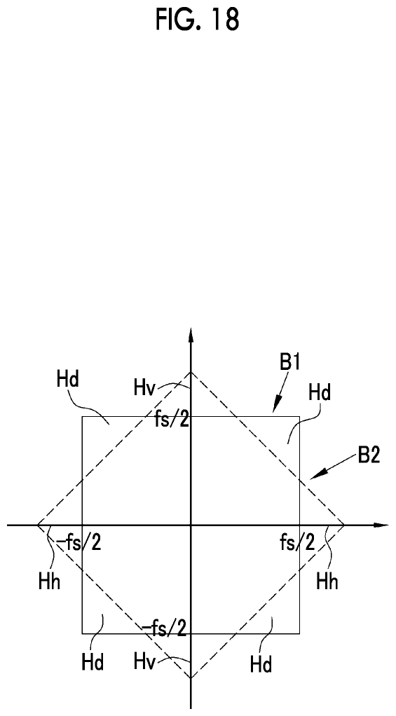

In the fourth embodiment, in order to generate a second image for learning illustrated in (B) of FIG. 17 in a pseudo manner from the first image, correction processing is performed on the first image. Here, in a stage before the correction processing, as illustrated in FIG. 18, in the first reproduction band B1 of the first image (after demosaicing processing), specific high-frequency components Hd in the oblique direction that are not included in the second reproduction band B2 of the second image (after demosaicing processing) are included, whereas specific frequency components Hh and Hv in the horizontal direction and the vertical direction that are included in the second reproduction band are not included.

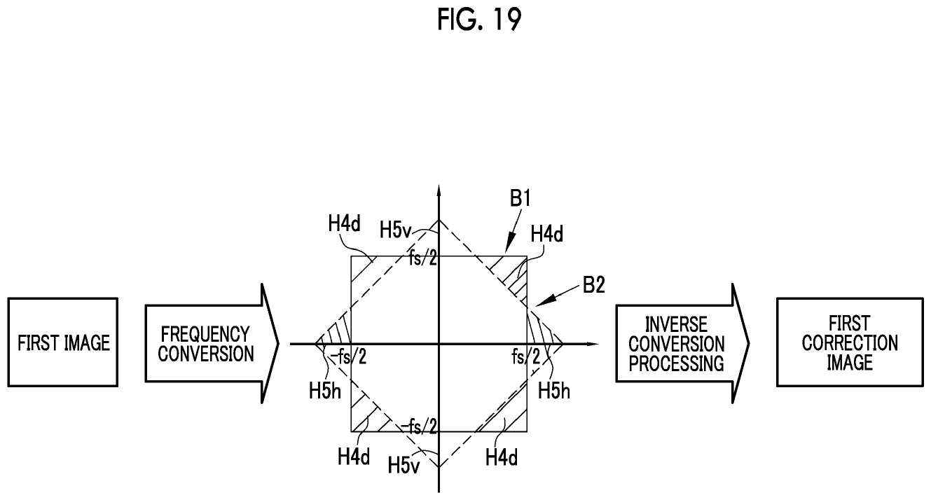

As illustrated in FIG. 19, in the correction processing according to the fourth embodiment, the first image is converted into an image in a frequency domain, and high-frequency components H5 that are included in the second reproduction band in the frequency domain are added in addition to high-frequency components H4 as reduction targets that are not included in the second reproduction band within the first reproduction band of the first image. The high-frequency components H4 as reduction targets are specific fourth high-frequency components H4d in the oblique direction. Further, the high-frequency components H5 are specific fifth high-frequency components H5h and H5v in the horizontal direction and the vertical direction. By performing inverse conversion processing on the first image from which the high-frequency components H4 as reduction targets are reduced or deleted and to which the high-frequency components H5 are added, a first correction image is generated, the inverse conversion processing being processing of converting an image in a frequency domain into an image in a pixel value domain. As a method of generating the high-frequency components H5 in a pseudo manner, a method of performing circumscribed interpolation from the frequency components of the first image before the correction processing, or a method of obtaining an average waveform of high-frequency components in a frequency domain of high frequencies corresponding to the frequency components of the first image after the correction processing may be used.

In the embodiments, a hardware structure of the processing unit that executes various processing, such as the first image acquisition unit 30, the second image acquisition unit 32, the correction processing unit 34, and the learning unit 36, is realized by the following various processors. The various processors include a central processing unit (CPU) which is a general-purpose processor that functions as various processing units by executing software (program), a graphical processing unit (GPU), a programmable logic device (PLD) such as a field programmable gate array (FPGA) which is a processor capable of changing a circuit configuration after manufacture, a dedicated electric circuit which is a processor having a circuit configuration specifically designed to execute various processing, and the like.

One processing unit may be configured by one of these various processors, or may be configured by a combination of two or more processors having the same type or different types (for example, a combination of a plurality of FPGAs, a combination of a CPU and an FPGA, a combination of a CPU and a GPU, or the like). Further, the plurality of processing units may be configured by one processor. As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure.

Further, as the hardware structure of the various processors, more specifically, an electric circuit (circuitry) in which circuit elements such as semiconductor elements are combined may be used. Further, a hardware structure of the storage unit is a storage device such as a hard disk drive (HDD) or a solid state drive (SSD).

### EXPLANATION OF REFERENCES

10: endoscope system
12: communication unit
14: first image database
16: second image database
20: user interface
22: CPU
24: RAM
26: ROM
28: display
30: first image acquisition unit
32: second image acquisition unit
34: correction processing unit
36: learning unit
100: endoscope system
102: endoscope
102a: insertion part
102b: operating part
102c: bendable part
102d: tip part
102f: observation mode switching switch
102g: still image acquisition instruction switch
102h: zoom operation part
103: light source device
104: processor device
105: display
106: user interface
107: extended processor device
108: extended display
B1: first reproduction band
B2: second reproduction band
Hd: high-frequency components in oblique direction
H1d: first high-frequency components in oblique direction
H2d: second high-frequency components in oblique direction
H3d: third high-frequency components in oblique direction
H4d: fourth high-frequency components in oblique direction
Hh: high-frequency components in horizontal direction
H2h: second high-frequency components in horizontal direction
H3h: third high-frequency components in horizontal direction
H5h: fifth high-frequency components in horizontal direction
Hv: high-frequency components in vertical direction
H2v: second high-frequency components in vertical direction
H3v: third high-frequency components in vertical direction
H5v: fifth high-frequency components in vertical direction
Md: medium-frequency components
Px: actual pixel
Py: imaginary pixel

What is claimed is:

1. An image processing apparatus comprising:
a processor configured to:
acquire a first image that is captured by a sensor having a first pixel arrangement pattern and includes a first reproduction band in a frequency domain;
acquire a second image that is captured by a sensor having a second pixel arrangement pattern and includes a second reproduction band different from the first reproduction band in the frequency domain;
generate a first correction image by correction processing of at least reducing or deleting high-frequency components that are not included in the second reproduction band within the first reproduction band of the first image; and
perform learning of a learning model for determining an examination target by using the first correction image and the second image.

2. The image processing apparatus according to claim 1,
wherein the second reproduction band is a band obliquely inclined with respect to the first reproduction band in the frequency domain, and
the high-frequency components are first high-frequency components in an oblique direction that are not included in the second reproduction band.

3. The image processing apparatus according to claim 1,
wherein the second reproduction band is a band lower than the first reproduction band in the frequency domain, and
the high-frequency components are second high-frequency components that are not included in the second reproduction band.

4. The image processing apparatus according to claim 1,
wherein the second reproduction band is a band that is lower than high-frequency components of the first reproduction band in a horizontal direction and a vertical direction in the frequency domain and that is obliquely inclined with respect to the first reproduction band, and
in the correction processing, as the high-frequency components, third high-frequency components that are components that are not included in the second reproduction band are reduced or deleted, and medium-frequency components that are not included in the second reproduction band in the frequency domain are reduced or deleted.

5. The image processing apparatus according to claim 1,
wherein the second reproduction band is a band obliquely inclined with respect to the first reproduction band by rotating the first reproduction band by a specific angle in the frequency domain,
the high-frequency components are fourth high-frequency components in an oblique direction that are not included in the second reproduction band, and
in the correction processing, fifth high-frequency components that are included in the second reproduction band are added in addition to the fourth high-frequency components.

6. The image processing apparatus according to claim 2,
wherein the first reproduction band has a square grid shape, and the second reproduction band has a rhombus shape.

7. The image processing apparatus according to claim 3,
wherein the first reproduction band and the second reproduction band have a square grid shape.

8. The image processing apparatus according to claim 1,
wherein the first pixel arrangement pattern is a pattern in which pixels are arranged in a square grid shape, and the second pixel arrangement pattern is a pattern in which pixels are arranged in a checkered grid shape.

9. The image processing apparatus according to claim 3,
wherein the first pixel arrangement pattern and the second pixel arrangement pattern are patterns in which pixels are arranged in a square grid shape or a checkered grid shape.

10. The image processing apparatus according to claim 1,
wherein the first image and the second image are images acquired by an endoscope.

11. A medical image processing apparatus comprising:
a learning model obtained by the learning in the image processing apparatus according to claim 1,
wherein an examination target is determined by using the learning model.
